(19) United States
(12) Patent Application Publication
(10) Pub. No.: US 2025/0112947 A1
(43) Pub. Date: Apr. 3, 2025

(54) ENHANCED CONTINUOUS MITIGATION SYSTEM THROUGH THE SURVEILLANCE OF KNOWN THREATS

(71) Applicant: Dell Products L.P., Round Rock, TX (US)

(72) Inventors: Werner Spolidoro Freund, Rio de Janeiro (BR); Roberto Nery Stelling Neto, Rio de Janeiro – RJ (BR)

(21) Appl. No.: 18/478,782

(22) Filed: Sep. 29, 2023

(51) Int. Cl. H04L 9/40

(52) U.S. Cl. CPC H04L 63/1433; H04L 63/1441

(57) ABSTRACT

One example method includes using a zero trust architecture to surveil a network to obtain information about a vulnerability in a network, determining, based on the information, a threat mitigation strategy responsive to the vulnerability, communicating the threat mitigation strategy to enable resource allocation for implementation of the threat mitigation strategy, allocating any needed resources for implementation of the threat mitigation strategy, and using the resources to implement the threat mitigation strategy.

### FIELD OF THE INVENTION

Embodiments of the present invention generally relate to surveillance of computing and/or other environments for threats. More particularly, at least some embodiments of the invention relate to systems, hardware, software, computer-readable media, and methods, for defining and using a CDM (continuous diagnostic and mitigation) system operable to harden a ZTA (zero trust architecture) by leveraging SIEM (security information and event management) surveillance capabilities.

### BACKGROUND

Some entities, such as business organizations, may use ZTAs to guide the development and implementation of security measures for services and assets. ZTAs may provide network activity surveillance through an SIEM system. Additionally, a CDM system may employed to gather information about the current state of the network and to apply updates in the configuration and software components. However, there are a variety of problems involved with attempting to create and implement a CDM system in connection with an environment such as a network.

For example, from the perspective of an attacker, if it is known that a network is kept without any flaws from the defender perspective, then the attacker has information that any vulnerabilities or weaknesses it finds on the network are unknown by the defender. This means that such weaknesses are always safe to be exploited, provided that there are low chances of the exploits to be detected, facilitating the attacker effort.

As another example, even if the defender strategy is to keep the system without any known flaws, the mitigation through an update is often not immediate, when there are no known patches available to resolve a security flaw, or the CDM system still cannot apply the update immediately, for example to avoid disrupting important network activities that would be affected by an update, the update would have to be scheduled to a later time, creating a vulnerability window. Typical CDM systems lack an alternative mitigation strategy that could be implemented during this window.

As a final example, SIEM surveillance efficiency is a function of its observability and security-centric information processing capabilities. Without proper prioritization on which information is relevant and information, providing promising paths the attacker is most likely to follow in the network, the surveillance system ends up collecting a large amount of frivolous data and is subject to combinatorial explosion of paths mostly irrelevant to security purposes.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an overall architecture of a SIM data collection module, according to one embodiment.

FIG. 2 discloses further details concerning the example architecture disclosed in FIG. 1.

FIG. 3 discloses aspects of an overall architecture of a SEM (security event management) surveillance module according to one embodiment.

FIG. 4 discloses aspects of an overall architecture of a ZTA-compliant CDM system according to an embodiment.

FIG. 5 discloses aspects of a general architecture of an enhanced SIEM System according to an embodiment.

FIG. 6 discloses aspects of a KTTM module and its interaction with the eSIM, eSEM and eCM modules, according to an embodiment.

FIG. 7 discloses aspects of example eCD modules and operations according to an embodiment.

FIG. 8 discloses aspects of an eCM system and associated operations according to one embodiment.

FIG. 9 discloses a computing entity operable to perform any of the disclosed methods, processes, and operations.

### DETAILED DESCRIPTION OF SOME EXAMPLE EMBODIMENTS

Embodiments of the present invention generally relate to surveillance of computing and/or other environments for threats. More particularly, at least some embodiments of the invention relate to systems, hardware, software, computer-readable media, and methods, for defining and using a CDM (continuous diagnostic and mitigation) system operable to harden a ZTA (zero trust architecture) by leveraging SIEM (security information and event management) surveillance capabilities.

An example embodiment of the invention may recognize that that known weaknesses and vulnerabilities, such as in a communication network or computing network for example, may be mitigated through proper surveillance. Thus, one embodiment of the invention comprises a mitigation strategy for CDM systems that builds on top of ZTA SIEM activity auditing capabilities, so as to provide enhanced network protection via prioritization of surveillance resource usage. One embodiment enhances CDM and SIEM systems with additional components, namely, a KTMO (known threat mitigation orchestrator) and a KTMM (known threat mitigation module), that implement, and/or enable implementation of, a strategy. Thus, an embodiment may still behave as a standard ZTA whenever it decides that it is the best strategy, and/or when dictated by internal policies of an organization.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one embodiment of the invention may create and employ an eCDM (enhanced CDM) strategy may provide mitigation of potential exploits while, at the same time, possessing various other useful properties. One such property that may be provided by an embodiment is that there may be negligible additional resource requirements the implement the eCDM strategy, due to the nature of its observability which may employ precise telemetry collection and specific behavior matching algorithms. Another property that may be provided by an embodiment is the ability to retrieve highly significant information when activity paths are only significant to a potential attacker, therefore providing efficient resource usage by the embodiment. As a final example, another property that may be provided by an embodiment is that an embodiment may require additional efforts by an attacker to avoid exposing their posture to the defender. Various other advantages of one or more example embodiments will be apparent from this disclosure.

### A. Context for an Example Embodiment of the Invention

### A.1 Zero Trust Architectures (ZTA)

In general, ZT is a cybersecurity approach that focus on users, assets, and resources. It has as a central tenet that trust is never granted implicitly, therefore the goal is to continuously verify network activity. ZTAs are IT (information technology) infrastructures that comply with ZT requirements.

### A.1.1 Threat Intelligence Feeds

An embodiment of the invention may employ threat intelligence feeds and may not necessarily depend on any particular intelligence feed source nor representation form. Information from threat intelligence feeds may enable improved control of a network by identifying known weaknesses and vulnerabilities of the network. Examples of threat intelligence feeds, such as may be employed in one or more example embodiments, comprise feeds provided by governmental agencies such as MITRE ATT&CK, CVE, and CWE, for example.

### A.1.2 Security Information and Event Management (SIEM)

A system according to one embodiment may relate to the monitoring of security-centric information. Within ZTAs, the network activity data in all of their aspects such as, for example, traffic, environment, device, and application, may be aggregated and stored by a SIM (security information management) system, within the SIEM system. The aggregation of heterogeneous data modalities may imply that such system demands flexible representation capabilities. The activity auditing may be performed by the SEM system, which may also be contained within SIEM. Auditing may involve multiple facets, and one example embodiment is particularly concerned with threat detection and incident management, that is, the ability to detect exploits performed by attackers in the network, and how to respond to the attackers/exploits.

Together, the SIM and SEM compose an embodiment of the SIEM system. The SIEM system may comprise an enhancement of a ZT reference system, but with an additional module dedicated to providing continuous mitigation capabilities of identified weaknesses and vulnerabilities via the allocation of specific dedicated resources. It is noted that an embodiment of the system does not require any additional aspect in the reference SIEM system, which may be regarded as a black box mechanism except for the specificities of the additional module.

### A.1.3 Continuous Diagnostics and Mitigations

As noted earlier herein, an embodiment of the invention may comprise a CDM system. One example CDM, disclosed in “Scott W. Rose, Oliver Borchert, Stuart Mitchell, S. C. (2020) ‘Zero Trust Architecture—NIST Special Publication 800-207’, NIST, p. 49. doi: 10.6028/NIST.SP.800-207.)” (“Rose”), incorporated herein in its entirety by this reference, may comprise various capabilities. These capabilities may include, for example, continuous diagnostics (CD)-gathering information about the current state of the enterprise asset, and continuous mitigation (CM)—applying updates to network configuration and software components. One example embodiment of the invention may extend the CM capabilities to go beyond solely applying updates although, if desired, the extended CM according to one embodiment may still behave as a reference CM module such as disclosed in Rose.

It is noted that a system according to one embodiment does not necessarily imply any additional requirements in the reference CD and CM modules. Rather, an embodiment may be built on top of any systems, configurations, modules, or other entities, that are compliant with ZTA requirements.

### B. Overview of an Example Embodiment of the Invention

An example embodiment acknowledges that known weaknesses and vulnerabilities may also be mitigated through proper surveillance. Thus, an embodiment comprises a mitigation strategy for CDM systems building on top of ZTA SIEM activity auditing capabilities that provides enhanced network protection via prioritization of surveillance resource usage. One embodiment may only enhance the CDM and SIEM systems with additional components, that is, the KTMO and the KTMM, that may collectively implement a mitigation strategy. Thus, an embodiment may still behave as the standard ZTA whenever it decides that it is the best strategy, or as dictated by internal policies.

In an embodiment, the KTMO within the SIEM system governs the KTMM, which may provide specific threat surveillance with minimal resource usage, therefore prioritizing SIEM resource usage to relevant paths critical to identify potential attackers. The CDM may determine, for each new threat, the surveillance rule, and a threat mitigation strategy, and may communicate with the KTMO providing its decisions. This approach may result in: [1] allocation of a KTMM for a novel vulnerability or weakness in the network, either due to novel threat intelligence or due to a misconfiguration with respect to the internal threat intelligence database; and/or [2] deallocation of a KTMM due to the CDM mitigation of a known threat via the application of an update.

In an embodiment, a determination of a mitigation strategy may be necessary to properly harden the network. The role of one mitigation strategy may be two-fold: [1] perform a meta-game and estimate the attacker interest in performing such exploit without revealing its posture; and, [2] avoid either exposing threats that can be critical to the system if they escape control or creating entrance doors to the system.

Note that an enhanced CDM (eCDM) strategy according to one embodiment, may be efficient in the sense providing proper mitigation of potential exploits while, at the same time, possessing properties such as, but not limited to: [1] negligible additional resource requirements due to the nature of its observability which relies on precise telemetry collection and specific behavior matching algorithms; [2] the ability to retrieve highly significant information once these activity paths are only significant to a potential attacker, therefore providing efficient resource usage; and [3] require additional efforts by the attacker to avoid exposing the posture of the attacker to the defender, such as an owner or operator of the network under attack.

As will be apparent from this disclosure, one or more example embodiments of the invention may possess various useful features and aspects. By way of example, and not limitation, an eCDM system according to one embodiment may: [1] be configured to decide to mitigate known weaknesses and vulnerabilities through surveillance by building upon ZT framework components instead of always forbidding those weaknesses and vulnerabilities in the network; provide an alternative approach for protecting the ZTA network-when there is no known update or safe configuration to remove the weaknesses or vulnerabilities from the network, or while the update or safe configuration cannot be applied; and, [3] provide an auxiliary, and efficient, intrusion detection mechanism by dedicating surveillance resources to paths that solely a malicious attacker is, and/or would be, interested in following. By way of contrast with an embodiment of the invention, current approaches fail to disclose or suggest monitoring known vulnerabilities and weaknesses identified from threat intelligence feeds by leveraging on ZTA surveillance capabilities as a mitigation strategy.

### C. Detailed Discussion of Aspects of an Example Embodiment of the Invention

### C.1 Introduction

An embodiment of the invention may leverage the knowledge of infrastructure weaknesses and vulnerabilities in favor of the defender, that is, the owner or operator of the network under attack or targeted for attack. By intentionally tolerating, and monitoring, the known points of interest for the attacker in the network, and responding to their exploits, the defender may be able to use such knowledge for various purposes, including: [1] protecting the network even when an update or safe configuration is not known or possible; and, at the same time, [2] obtaining a highly efficient attack detection mechanism requiring the observability of a very limited set of information, and a specific parsing algorithm. In an embodiment, these specifications may in only negligible resource requirement from the network assets.

Put another way, an embodiment of the invention may provide a powerful mitigation strategy and additional component to SIEM systems with high trade-off between detection capabilities and resource requirements. Furthermore, the usage of known weaknesses this way may enable the defender to add additional constraints in the attacker perspective that results in additional effort for its success. Potential attacker strategies addressed by an embodiment of the invention may include: [1] considering which flaws or vulnerabilities are more or less likely to be monitored by the defender; and [2] attempting to retrieve the defender threat intelligence knowledge in some way, or both [1] and [2]. It is noted that a system and method according to one embodiment of the invention may be orthogonal to other ZTA components, and as such may define only enhancements to a reference ZTA CM module and one additional SIEM system component, therefore resulting in a highly beneficial detection-to-resource trade-offs on top of a ZT reference architecture, such as the ZT reference architecture disclosed in “DISA and NSA, 2021. Department of Defense Zero Trust Reference Architecture, Version 1.0” (“DISA”) which is incorporated herein in its entirety by this reference.

### C.2 ZTA Systems

It is noted initially that the scope of the invention is not limited to any specific embodiment disclosed herein. As such, any example embodiments disclosed herein are provided for the purpose of illustration, and to demonstrate that a system according to one embodiment of the invention may be built on top of currently available technologies. As addressed in more detail below, one example embodiment may build on top of a reference ZTA, and such embodiment may implement, and use, a reference ZTA SIEM System, and a SIM system.

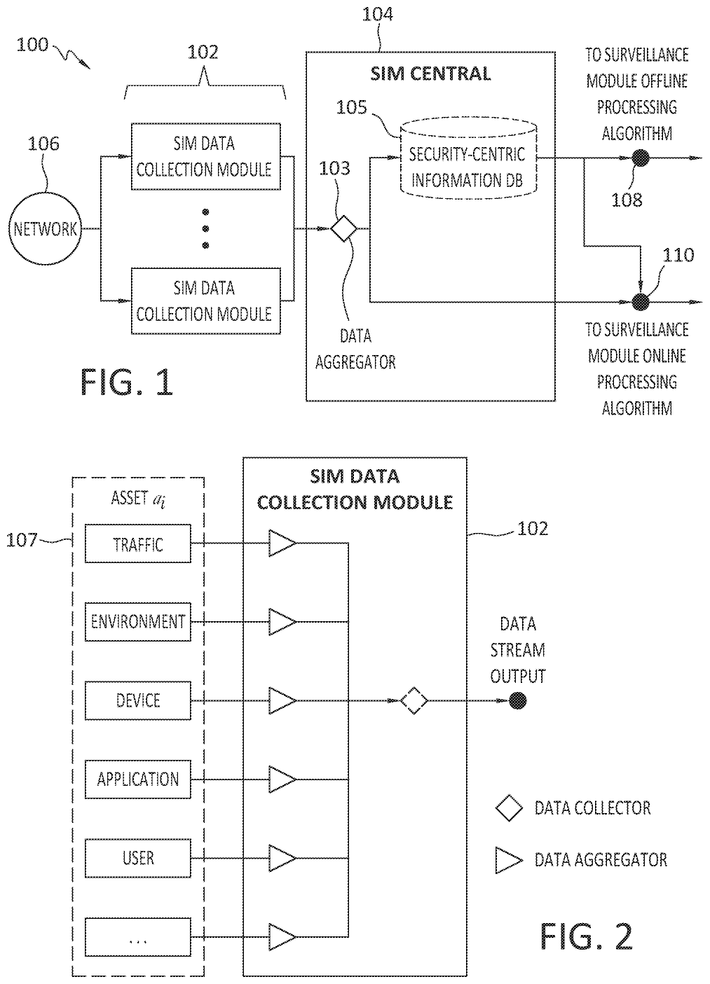

With reference now to FIGS. 1 and 2, examples of a SIM system, and SIM data collection module are disclosed. In the example of FIG. 1, a SIM system 100 takes the form of a data management center that may comprise one or more SIM data collection modules 102 configured to interact with a data aggregator 103 of a SIM central unit 104 that may additionally comprise a database 105 for storing information collected by, and received from, the SIM data collection module(s) 102. In an embodiment, the SIM data collection module(s) 102 may comprise a module dedicated to collect security-centric information from a specific subset of entities, such as an asset aᵢ for example, in a network 106 and then to stream such information to the SIM central unit 104. In one embodiment, a SIM data collection module 102 is not necessarily in the form of a physical instrumentation layer in the network, but may comprise a specific data collection cell in a data management system. The information is expected to be obtained from heterogenous data sources 107, or asset aᵢ, for example network traffic, specific environment configuration, device specificities, application, and user information. These data may be integrated within the SIM data collection module 102 or later on in the SIM central unit 104, and then transmitted to a surveillance module offline processing algorithm 108 and/or to a surveillance module online processing algorithm 110.

With continued reference to FIGS. 1 and 2, the example SIM central unit 104 may, as noted above, comprise a data aggregation module 103, as noted, and a database 105. While various forms may be used, a graph representation of security-centric information may, in an embodiment, provide additional beneficial aspects due to its flexible representation which facilitates ingestion of heterogeneous data.

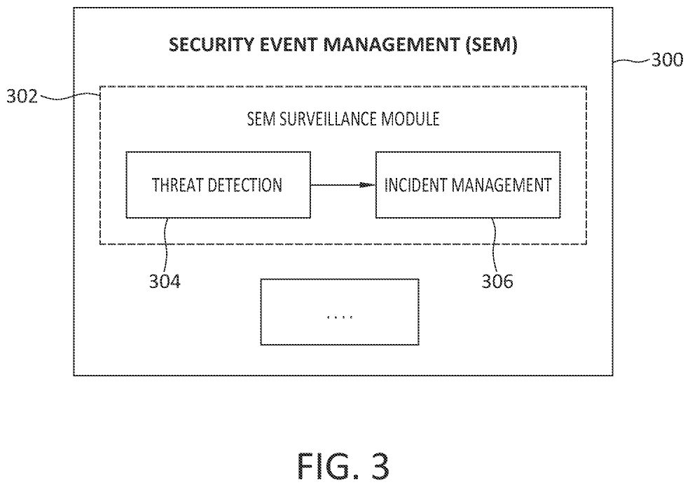

Turning next to FIG. 3, an example embodiment of an SEM module 300 is disclosed. In general, the SEM module 300 may retrieve information from a SIM system, such as the example SIM system 100, and may perform activity auditing of the entire network events.

As shown in FIG. 3, the SEM module 300 may comprise an SEM module 302 which may comprise a threat detection module 304 and incident management module 306 which together provide various surveillance capabilities. The SEM module 300 may comprise specific algorithm forms to be processed online and offline. While the specific embodiment of a threat detection approach and algorithm may vary, it is noted that graph queries on top of KG (knowledge graph) representation of network activity data may provide various useful aspects in on or more embodiments of the invention.

Such aspects may include, for example: query languages may be broadly employed and well-known in many application fields; an embodiment may benefit from extensively tested technology designed for scalability; an embodiment may use queries to provide low latency responses, allowing online operation as required by the SIEM and CDM system operations; and, an embodiment may comprise queries that provide responses that maintain the original data representation, and facilitating downstream processing. Thus, an incident management module 306 may retrieve the data obtained in those queries and processes that through downstream tasks, such as backward information processing for root cause analysis, forward information processing for diffusion control, and alert generation. Examples of such downstream tasks are disclosed in “Kurniawan, K., Ekelhart, A., Kiesling, E., Quirchmayr, G., Tjoa, A. M., 2022. KRYSTAL: Knowledge graph-based framework for tactical attack discovery in audit data. Computers & Security 121, 102828. https://doi.org/10.1016/j.cose.2022.102828”) (“Kurniawan”), incorporated herein in its entirety by this reference.

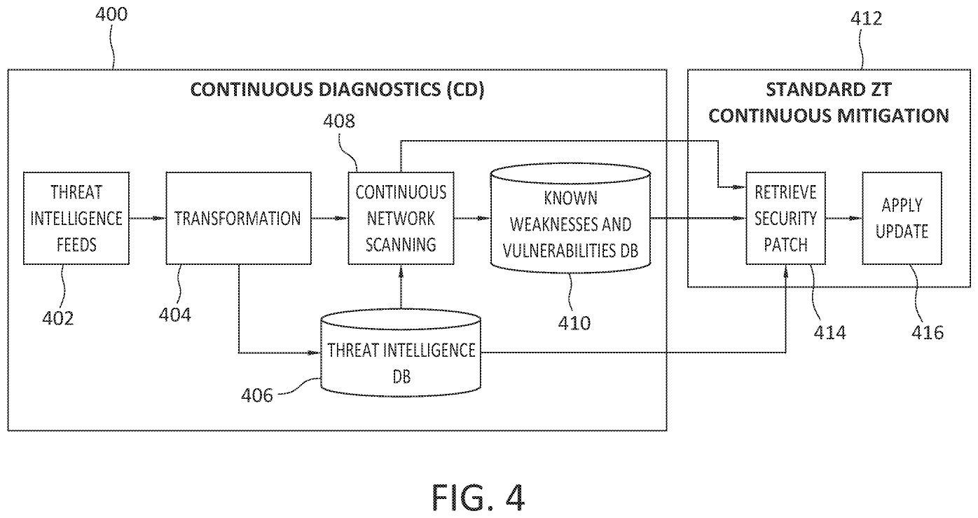

With reference next to FIG. 4, an example of a CDM system, or module, 400 is disclosed. In general, the CDM module 400 may continuously retrieve threat intelligence information and scan the network for determining potential threats. One example embodiment of a CDM module may be based on “Lyft, 2022. Cartography. Available at: https://github.com/lyft/cartography” (“Cartography”) (incorporated herein in its entirety by this reference) where CVE and other threat intelligence feeds are consolidated together with infrastructure assets in a KG. Another example embodiment of a CDM module may comprise an adaptation of Kurniawan by leveraging the disclosed SEPSES Cyber-KG CVE representation to provide Cartography-like capabilities. Commercial solutions, such as Kenna Security software, may be used in an embodiment.

With more detailed reference now to the example of FIG. 4, threat intelligence information containing known vulnerabilities and weaknesses may retrieved and parsed from internal and external sources, such as the threat intelligence feeds 402. A transformation module 404 may also be provided by way of which the information from the threat intelligence feeds 402 is aggregated and transformed to a standard representation format. The embodiment for the representation is particularly suited for flexible representations that allow uniform usage of the information content in various feeds. Thus, one example embodiment may employ Knowledge Graph (KG) representations, examples of which are disclosed in Kurniawan and Cartography, that implement such functionalities.

The transformation module 404 may communicate with a threat intelligence DB 406, of the CDM module 400, which may hold aggregated threat intelligence data after the transformation by the transformation module 404. Information, data, and metadata, from the threat intelligence DB 406 may be examined by a continuous network scanning module and/or process 408, together with novel incoming threat information. A known threat intelligence information is denoted by tᵢ∈ [symbol] , and may contain information about the specific configuration or software component that generates a threat in the network, and how that information might be exploited by an attacker. In an embodiment, the continuous network scanning 408 may be performed whenever novel threat intelligence information is gathered from the threat intelligence feeds 402 or in continuous intervals to ensure that the CDM module 400 is aware of any known weakness and vulnerability due to changes in the network structure.

The example CDM module 400 may further comprise a known weaknesses and vulnerabilities DB 410 which may contain all weaknesses and vulnerabilities found in the network. As used herein, a known weakness or vulnerability is denoted by nᵢ∈ [symbol] and may contain information about the specific entities affected in the network and a pointer to its threat intelligence information tᵢ. Note that several known weakness or vulnerabilities may be due to the same threat intelligence information, that is, the cardinality of the set [symbol] ={nᵢ|tᵢ=tⱼ} may, and is expected to in some circumstances, be greater than one. As used herein, [symbol] denotes all known weaknesses and vulnerabilities.

As further indicated in the example of FIG. 4, the CDM module 400 may interact with a standard ZT continuous mitigation (CM) module 412. In the standard ZTA definition, the CM module 412 may then, based on input received from the CDM module 400, determine, and retrieve 414, the security patch, relating to a particular weakness or vulnerability, and apply 416 that patch to the appropriate asset(s). In a ZTA, this patching process may be automatically performed. Note that a potential solution may be achieved via a rule-based approach on top of the KG representation of threat intelligence feeds and the system/application specifications, as disclosed in “Mubin U L Haque, M. Mehdi Kloloosi, et al. KGSecConfig: A Knowledge Graph Based Approach for Secured Container Orchestrator Configuration, 2022 IEEE/SANER” (“Haque”), which is incorporated herein in its entirety by reference.

Various network properties may be specified and employed in one or more embodiments of the invention. These may include general network properties. One such general network property is the cost C, which refers to the resource usage of SIEM and CDM systems, and thus may contain contributions from collecting and aggregating data, parsing the data for activity auditing purposes, continuously scanning the system for threats, and determining the mitigation strategy. For simplicity, the cost C may be expressed as a vector and may include asset, network, and dedicated ZTA monitoring resources in separated dimensions of the vector. Another example general network property is the budget B which refers to the available resource budget, and may have the same dimensions as C.

### C.3 Example ZTA System Enhancements

As noted above, an embodiment of the invention may comprise a non-disruptive generalization, and/or addition/extension, to a ZTA reference architecture, that may enable better control of the network by the defender, but which may also provide the original behavior whenever it is the best scenario or intentionally desired by the network operators. Following is a discussion of some example enhancements, provided by an embodiment of the invention, to the standard ZTA system, that may provide various useful functionalities.

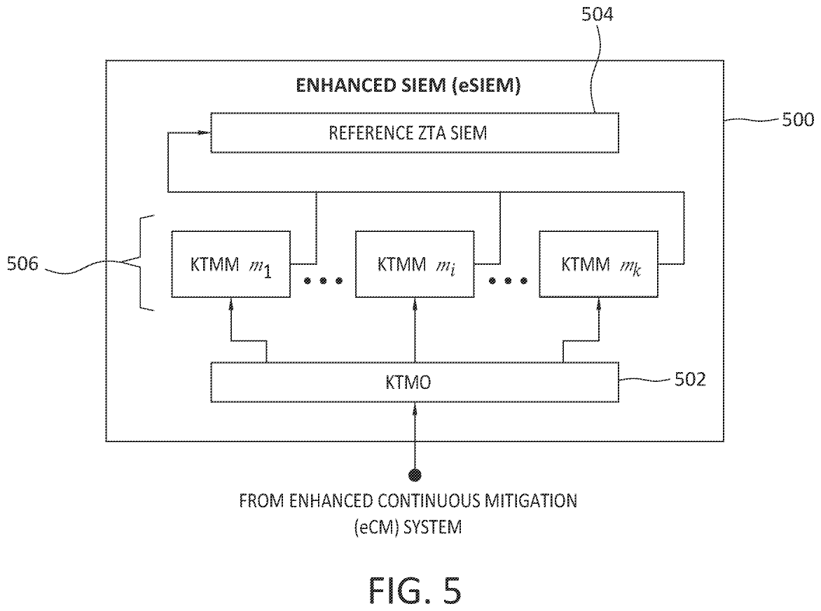

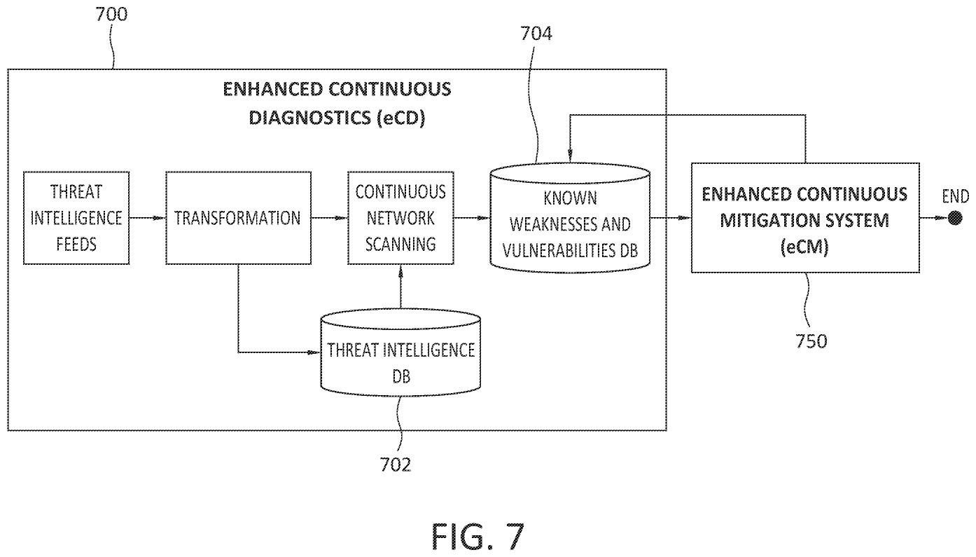

With particular reference to the example of FIG. 5, there is disclosed an embodiment of an enhanced SIEM (eSIEM) system 500. In this example, the enhancement may comprise a KTMO module 502, incorporated together with a reference ZTA SIEM 504, and which may govern one or more KTMM modules 506. The KTMO module 502 may implement a strategy defined by an enhanced CD (eCD) module (see FIG. 7). The KTMO module 502 may ensure that the resources are allocated and deallocated correctly. The KTMO module 502 may retrieve the observability and surveillance algorithms from the eCD module and instantiate new KTMM modules 506 with a desired configuration.

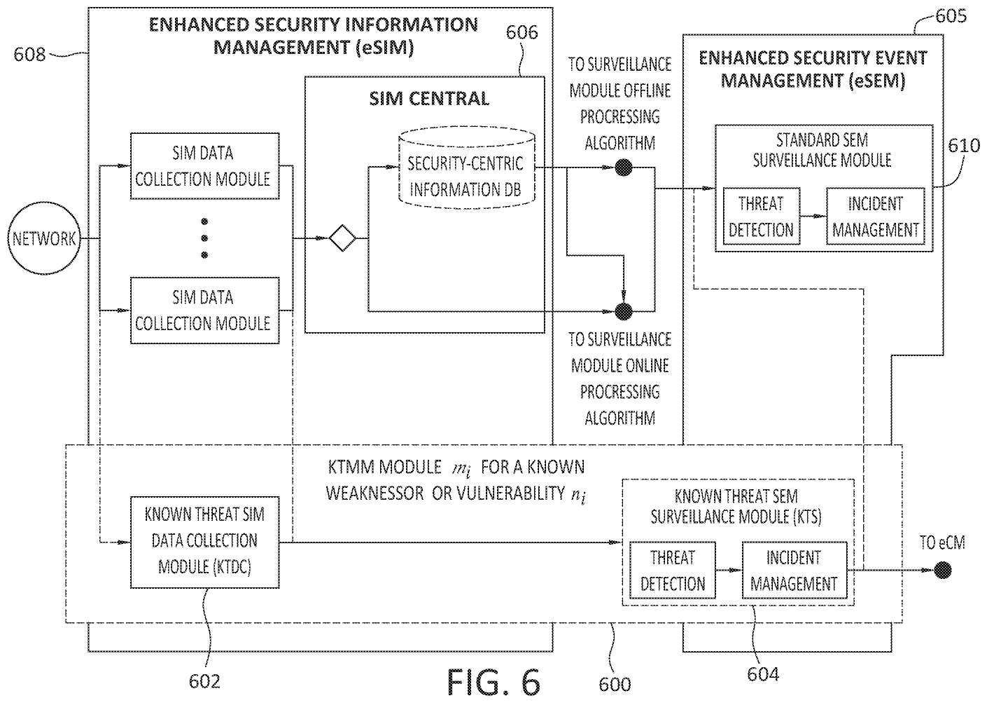

The KTMM module(s) 506 (see also, FIG. 6) may add specific observability and surveillance processing requirements, respectively, to SIM and SEM systems, examples of which are disclosed in FIG. 6, for a specific vulnerability or weakness. In an embodiment, the KTMM 506 may comprise two modules, namely, a KTDC (known threat SIM data collection) module, and a KTS (known threat SEM surveillance) module. That is, as shown in FIG. 6, a KTMM module 600 may comprise a KTDC module 602, and a KTS module 604 that may, in an embodiment, be incorporated as an element of an eSEM (enhanced security event management) module 605.

In more detail, and with continued reference to the example of FIG. 6, the KTDC module 602 may be dedicated to collecting solely the required information to determine whether some activity matches the exploitation pattern defined in the threat information tᵢ corresponding to nᵢ. In an embodiment, there may be no additional requirements to the components of the KTDC module 602, and the same embodiments may be considered as described herein for the DCM (data collection module). The KTDC module 602 may communicate to a SIM central module 606, which may be an element of an eSIM module 608, which may include the KTDC 602 as one of its elements, so as to ensure that the eSIEM system (see 500 in FIG. 5) always has access to the information relevant to evaluate the exploit of the threat tᵢ in the specific nᵢ. In an embodiment, the collected information may be directly sent by the KTDC module 602 to the KTS module 604.

In an embodiment, the KTS module 604 may process only a relevant fraction of the information provided by its respective KTDC 602, thus reducing the processing strains in the system to detect an exploitation of threat tᵢ in the specific nᵢ. There may be no additional requirements to the components of the KTDC 602 and the same embodiments may be considered as described herein for the DCM (see 102 in FIG. 1, for example) and SEM (see 300 in FIG. 3, for example) modules.

In an embodiment, the KTS module 604 may count with a specific incident management module that may execute contextualized checks considering the network specificities of the particular nᵢ. For instance, nᵢ may be a specific backend located before a specific frontend in such a way that it might be interesting to evaluate specific root cause analysis on top of the frontend, or to trigger detailed data collection for the specific frontend. The incident management may also be expected to properly respond to the activity, for example, by interrupting, or preventing, that activity.

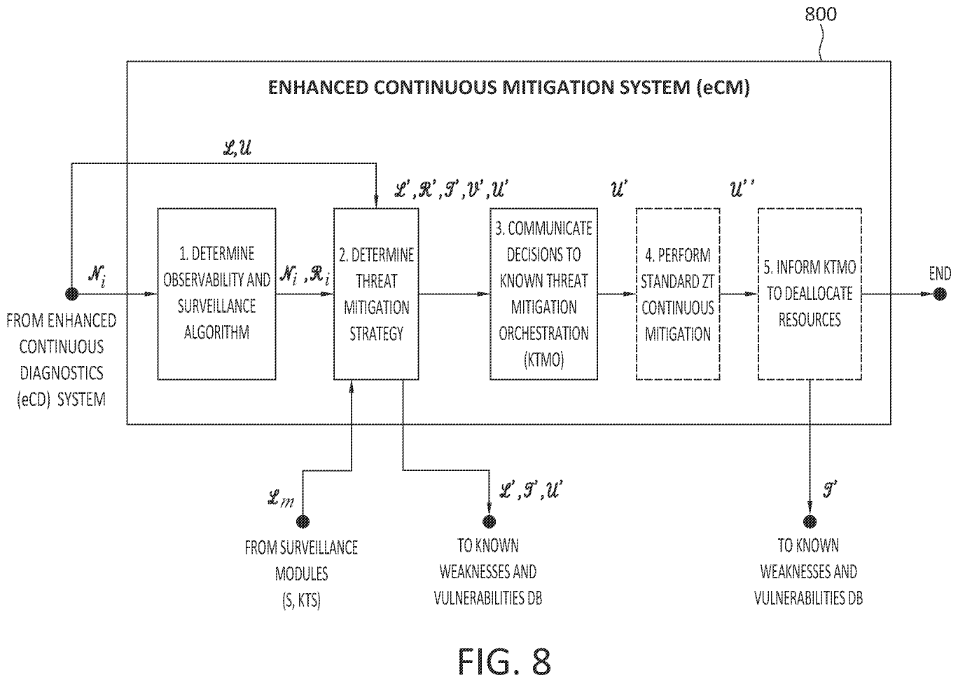

Further, one or more of the KTS modules 604 may also communicate with a standard SEM module 610 of the eSIM 605 to execute threat detection on top of the full security-centric information, where general incident management and global resolution may be possible. The information may also be forwarded to an eCM module (see FIG. 8) that may determine to apply an update or to continue with the surveillance depending on the eCM module policies.

Turning now to FIG. 7, discussion of eCDM (enhanced continuous mitigation and diagnostics) is provided that concerns, among other things, an example eCD (enhanced continuous diagnostics) module 700. In an embodiment, the structure of the eCD module 700 may be similar, or identical, to the structure of the CD module 400.

Reference is first made to the eCD module 700. In one embodiment, and relative to the CD module 400 disclosed in FIG. 4, the only changes included in the eCD module 700 concern additional information in the threat intelligence DB 702 and the known weaknesses and vulnerabilities DB 704, which holds additional information, which may be provided to the eCM 750, concerning CM strategy decisions. In particular, the known weaknesses and vulnerabilities DB 704 may store additional information that enables the splitting of a set of known weaknesses and vulnerabilities [symbol] into disjoint subsets—here, the set of known weaknesses and vulnerability that are to be mitigated by an update is denoted by [symbol] , and the respective set mitigated through surveillance is denoted by [symbol] . With continued reference to the example of FIG. 7, the eCM module 750 may be executed whenever the new vulnerability or weakness is observed, or when novel suspicious activity is observed involving elements in [symbol] .

With reference now to FIG. 8, an example embodiment of an eCM module 800 is disclosed. In particular, FIG. 8 discloses an eCM module 800, and aspects of the interaction of the eCM module 800 with various other modules, such as ZTA modules. Note that the eCM module 800, like the other modules disclosed herein, may be implemented as, comprise, and/or execute, an algorithm, and/or executable code.

Example algorithmic operations are disclosed in FIG. 8 and may comprise the following methods, processes, and operations. The first operation (1) may be implemented by a algorithm for determining observability and performing surveillance-particularly, provided a batch of new vulnerabilities and weaknesses [symbol] , determine the information to be retrieved and the corresponding surveillance algorithm. The results may be placed in a list [symbol] aligned with [symbol] and passed to the next step. One example embodiment for determining the surveillance algorithm may follow graph query transformations, such as are disclosed in Kurniawan for example, while determining the observability can involve the usage of mapping from the requirements for the surveillance queries to activate specific KTDC collection flags for the entities affected by nᵢ which may benefit from ontology descriptions such as are disclosed in Kurniawan.

The next operation (2) implemented by the example eCM module 800 may be to determine a threat mitigation strategy. This detection may be triggered as a result of the observation of new vulnerabilities or suspicious activities detected by a KTMM. Performance of (2) may generate various outputs including, but not limited to: (a) a set of new vulnerability and weakness entities that require permanent surveillance [symbol] and their algorithm configuration metadata [symbol] ; (b) a set of new vulnerability and weakness entities that require temporary surveillance [symbol] ′ and their algorithm configuration metadata [symbol] ′; and (c) a set of already monitored vulnerability and weakness entities [symbol] ′ that have been chosen for a mitigation strategy via configuration update. The outputs [symbol] ′, [symbol] ′ and [symbol] ′ may be used to update the eCD known weaknesses and vulnerabilities DB 704 [symbol] and [symbol] sets.

In operation (3), decisions made at (2) may be communicated to a KTMO. Particularly, the eCM module 800 may inform the KTMO of its strategy decisions described by the outputs of (2), discussed above. The KTMO may then make the appropriate changes, including allocating new instances based on [symbol] ′, [symbol] ′, [symbol] ′, [symbol] ′ and/or preparing resources for deallocation [symbol] ′.

Proceeding to operation (4), if [symbol] ′∅Ø, then perform the standard ZT CM operations as described disclosed earlier herein (see, for example, reference 412 of FIG. 4). Let [symbol] ″ denote the entities which resulted in successful execution. If [symbol] ′\ [symbol] ″≠∅, trigger a failure strategy. In a simple embodiment, (4) may comprise triggering a warning and setting [symbol] = [symbol] ∪ [symbol] ′\ [symbol] ″.

At operation (5), if [symbol] ″≠∅, then inform KTMO to deallocate [symbol] ″ corresponding KTMMs. Further, [symbol] ″ may be used to update the eCD Known Weaknesses and Vulnerabilities DB 704, [symbol] and [symbol] sets, removing from the latter and adding to the former.

C.4 Example mitigation strategy

Recall that, as disclosed herein, the security-driven modules may have a limited resource budget B to perform the surveillance of the network. This may particularly apply to the SIEM module, which may determine the prioritization of what information collect and how to process the collected information efficiently. In the last case, there may also be further strains in the system to provide low latency response. Since the online operation may be modelled as additional dimensions in the budget vector, the following discussion is simplified somewhat to improve the clarity of exposition.

C.4.1 Resource usage

An eCM module according to one embodiment, such as the eCM module 800 for example, may choose two mitigation strategies for each vulnerability or weakness detected in the network, each with its advantage and/disadvantage. A standard CM approach may eventually solve the problem whenever the update is successfully applied but does not provide additional detection capabilities for the SIEM module. On the other hand, the surveillance approach provides such detection capabilities at the expense of additional overhead in the system. Although the increase in computational cost Cₑ may be much smaller than the standard SIEM activities, the system may still have to perform standard security-based activities with its associated cost Cₛ, so that the available budget for the enhanced Bₑ=C−Cₛ may not be large enough to determine all nodes to [symbol] ′.

Further, even if Bₑ>>Cₑ, there may be an associated risk that the response to an exploit fails in some occasions, for example, the system response might be too slow and the attacker may scale its permissions beyond diffusion control capabilities, and the KTTM and its backup may become unresponsive for some particular fault in the computational resources exactly in the moment of the exploit and before the KTMO can allocate an additional instance. In an embodiment then, the defender should avoid exposing critical resources to such potential exploits.

It is noted that there may be occasions that even if the eSIEM can be ensured to work perfectly, there is no interest for the defender to expose network entities to such exploits. This is particularly true for frontends and other devices that are subject to external traffic. The defender may gain little by exposing such devices, as it is known that there are always attackers interested in exploiting them. Therefore, the defender may avoid assigning instances of [symbol] ᵢ to [symbol] ′ in both cases.

On other occasions, the defender may have no option except to assign some instances in [symbol] ᵢ to [symbol] ′, in particular when the update to mitigate a nᵢ is unknown. This means that the system may have to estimate a fraction of Bₑ to incoming vulnerabilities and weaknesses of this type.

Several methods to determine the policies for the mitigation strategy may be derived based on workload placement literature, and considering the heuristics described above. Thus, it is noted that simple policies may provide a good starting point based on these heuristics. For example, it is possible to determine to prioritize internal backend to be assigned to [symbol] ′, especially those near to frontends and not exposing critical information, and to determine a threshold whether the system should avoid instantiating more resources to keep budget for instances that must be allocated to [symbol] ′.

C.4.2 Improving detection

Another aspect to be considered in some scenarios may be the choice of which threats to keep, as some might be considered more interesting or known to the attacker, therefore increasing the chances for the attacker to expose its posture, and thus enable the defender to formulate and implement corresponding strategies for defeating attacks by the defender. In an embodiment, the choice may depend on the popularity of a threat as determined by the threat intelligence feed. In other cases, the defender may expose specific vulnerabilities that are not well known, specially if the defender notices that the attacker is attempting to avoid known vulnerabilities. It is further noted that an embodiment of the system may determine to replace one nᵢ∈ [symbol] by a novel nⱼ∈ [symbol] depending on a policy based on such heuristics.

### D. Example Methods

It is noted with respect to the disclosed methods, including the example method of FIGS. 1, 4, and 6-8, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### E. Further Example Embodiments Following are some further example embodiments of the invention. These are

presented only by way of example and are not intended to limit the scope of the invention in any way.

Embodiment 1. A method, comprising: using a zero trust architecture to surveil a network to obtain information about a vulnerability in a network; determining, based on the information, a threat mitigation strategy responsive to the vulnerability; communicating the threat mitigation strategy to enable resource allocation for implementation of the threat mitigation strategy; allocating any needed resources for implementation of the threat mitigation strategy; and using the resources to implement the threat mitigation strategy.

Embodiment 2. The method as recited in any preceding embodiment, wherein the information indicates how the vulnerability could be exploited by an attacker.

Embodiment 3. The method as recited in any preceding embodiment, wherein the vulnerability is a known vulnerability.

Embodiment 4. The method as recited in any preceding embodiment, wherein the resources are minimum resources needed to implement the threat mitigation strategy.

Embodiment 5. The method as recited in any preceding embodiment, wherein when a different vulnerability is identified, a security patch to correct the different vulnerability is obtained and automatically applied, by the zero trust architecture, to resolve the different vulnerability.

Embodiment 6. The method as recited in any preceding embodiment, wherein determining the threat mitigation strategy comprises estimating attacker interest in exploiting the new vulnerability without revealing a posture of the attacker to a defender of the network.

Embodiment 7. The method as recited in any preceding embodiment, wherein when the threat mitigation strategy cannot be implemented immediately, an alternative threat mitigation strategy is implemented before the threat mitigation strategy.

Embodiment 8. The method as recited in any preceding embodiment, wherein implementing the threat mitigation strategy comprises applying an update to a network configuration and/or to a software component of the network.

Embodiment 9. The method as recited in any preceding embodiment, wherein a different vulnerability identified in the network is intentionally tolerated, and not mitigated.

Embodiment 10. The method as recited in any preceding embodiment, wherein the vulnerability is the new vulnerability.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

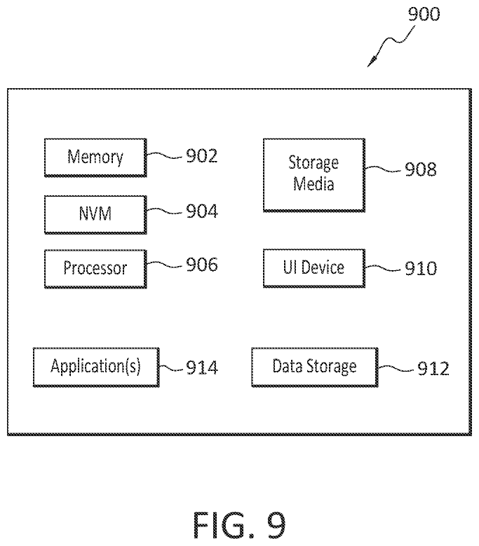

With reference briefly now to FIG. 9, any one or more of the entities disclosed, or implied, by FIGS. 1-8, and/or elsewhere herein, may take the form of, or include, or be implemented on, or hosted by, a physical computing device, one example of which is denoted at 900. As well, where any of the aforementioned elements comprise or consist of a virtual machine (VM), that VM may constitute a virtualization of any combination of the physical components disclosed in FIG. 9.

In the example of FIG. 9, the physical computing device 900 includes a memory 902 which may include one, some, or all, of random access memory (RAM), non-volatile memory (NVM) 904 such as NVRAM for example, read-only memory (ROM), and persistent memory, one or more hardware processors 906, non-transitory storage media 908, UI device 910, and data storage 912. One or more of the memory components 906 of the physical computing device 900 may take the form of solid state device (SSD) storage. As well, one or more applications 914 may be provided that comprise instructions executable by one or more hardware processors 906 to perform any of the methods, processes, steps, operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
using a zero trust architecture to surveil a network to obtain information about a vulnerability in a network;
determining, based on the information, a threat mitigation strategy responsive to the vulnerability;
communicating the threat mitigation strategy to enable resource allocation for implementation of the threat mitigation strategy;
allocating any needed resources for implementation of the threat mitigation strategy; and
using the resources to implement the threat mitigation strategy.

2. The method as recited in claim 1, wherein the information indicates how the vulnerability could be exploited by an attacker.

3. The method as recited in claim 1, wherein the vulnerability is a known vulnerability.

4. The method as recited in claim 1, wherein the resources are minimum resources needed to implement the threat mitigation strategy.

5. The method as recited in claim 1, wherein when a different vulnerability is identified, a security patch to correct the different vulnerability is obtained and automatically applied, by the zero trust architecture, to resolve the different vulnerability.

6. The method as recited in claim 1, wherein determining the threat mitigation strategy comprises estimating attacker interest in exploiting a new vulnerability without revealing a posture of the attacker to a defender of the network.

7. The method as recited in claim 1, wherein when the threat mitigation strategy cannot be implemented immediately, an alternative threat mitigation strategy is implemented before the threat mitigation strategy.

8. The method as recited in claim 1, wherein implementing the threat mitigation strategy comprises applying an update to a network configuration and/or to a software component of the network.

9. The method as recited in claim 1, wherein a different vulnerability identified in the network is intentionally tolerated, and not mitigated.

10. The method as recited in claim 1, wherein the vulnerability is a new vulnerability.

11. A non-transitory storage medium having stored therein instructions that are executable by one or more hardware processors to perform operations comprising:
using a zero trust architecture to surveil a network to obtain information about a vulnerability in a network;
determining, based on the information, a threat mitigation strategy responsive to the vulnerability;
communicating the threat mitigation strategy to enable resource allocation for implementation of the threat mitigation strategy;
allocating any needed resources for implementation of the threat mitigation strategy; and
using the resources to implement the threat mitigation strategy.

12. The non-transitory storage medium as recited in claim 11, wherein the information indicates how the vulnerability could be exploited by an attacker.

13. The non-transitory storage medium as recited in claim 11, wherein the vulnerability is a known vulnerability.

14. The non-transitory storage medium as recited in claim 11, wherein the resources are minimum resources needed to implement the threat mitigation strategy.

15. The non-transitory storage medium as recited in claim 11, wherein when a different vulnerability is identified, a security patch to correct the different vulnerability is obtained and automatically applied, by the zero trust architecture, to resolve the different vulnerability.

16. The non-transitory storage medium as recited in claim 11, wherein determining the threat mitigation strategy comprises estimating attacker interest in exploiting a new vulnerability without revealing a posture of the attacker to a defender of the network.

17. The non-transitory storage medium as recited in claim 11, wherein when the threat mitigation strategy cannot be implemented immediately, an alternative threat mitigation strategy is implemented before the threat mitigation strategy.

18. The non-transitory storage medium as recited in claim 11, wherein implementing the threat mitigation strategy comprises applying an update to a network configuration and/or to a software component of the network.

19. The non-transitory storage medium as recited in claim 11, wherein a different vulnerability identified in the network is intentionally tolerated, and not mitigated.

20. The non-transitory storage medium as recited in claim 11, wherein the vulnerability is a new vulnerability.
